(19) United States
(12) Patent Application Publication
(10) Pub. No.: US 2026/0302834 A1
(43) Pub. Date: Oct. 1, 2026

(54) CHARGEABLE DEVICE AND RECEIVER

(71) Applicant: NICOVENTURES TRADING LIMITED, London (GB)

(72) Inventors: Daming ZHANG, Shenzhen (CN); Yang ZHONG, Shenzhen (CN)

(21) Appl. No.: 19/478,571

(22) PCT Filed: Apr. 25, 2024
(86) PCT No.: PCT/GB2024/051082

§ 371 Date: Oct. 24, 2025

(30) Foreign Application Priority Data
Apr. 26, 2023 (CN) 2023104633623
Jun. 27, 2023 (GB) 2309663.9

(51) Int. Cl. H02J 50/12; A24F 40/90

(52) U.S. Cl. CPC H02J 50/12; A24F 40/90

(57) ABSTRACT

A resonant receiver is described comprising: a first circuit configured to receive electrical power by magnetic resonance induction; and a connector for connecting to a charging port of an electrically chargeable aerosol generating device. In use, the resonant receiver is connectable to a charging port of an electrically chargeable aerosol generating device. Power is received at the first circuit and at least some of received electrical power is transferred to the electrically chargeable aerosol generating device.

### FIELD

Example embodiments describe a chargeable device, for example a chargeable aerosol generating device.

### BACKGROUND

Smoking articles, such as cigarettes, cigars and the like burn tobacco during use to create tobacco smoke. Attempts have been made to provide alternatives to these articles by creating products that release compounds without combusting. For example, tobacco heating devices heat an aerosol provision substrate such as tobacco to form an aerosol by heating, but not burning, the substrate. There remains a need for further developments in this field.

### SUMMARY

The scope of protection sought for various embodiments of the invention is set out by the independent claims. The embodiments and features, if any, described in this specification that do not fall under the scope of the independent claims are to be interpreted as examples useful for understanding various embodiments of the invention.

According to a first aspect, there is described a resonant receiver comprising a first circuit configured to receive electrical power by magnetic resonance induction; and a connector (e.g. a 2-pin connector) for connecting to a charging port of an electrically chargeable aerosol generating device and transferring at least some of said received electrical power to said electrically chargeable aerosol generating device, wherein said connector is detachable from said charging port.

The resonant receiver may further comprise a securing arrangement (such as a magnet) for securing the connector to said charging port.

The first circuit may comprise a receive coil and/or a rectifier.

The first circuit may be housed in a non-metallic shell.

According to a second aspect, there is described a method comprising: connecting a resonant receiver to a charging port of an electrically chargeable aerosol generating device; receiving electrical power, at a first circuit of said resonant receiver, by magnetic resonance induction; and transferring at least some of said received electrical power to said electrically chargeable aerosol generating device. The method may further comprise securing the connector to said charging port (e.g. using a magnet).

The method may further comprise detaching said resonant receiver from the charging port of said electrically chargeable aerosol generating device.

According to a third aspect, there is described a kit of parts comprising: an electrically chargeable aerosol generating device; and a resonant receiver as set out above with reference to the first aspect, wherein said resonant receiver is detachable from said electrically chargeable aerosol generating device. The electrically chargeable aerosol generating device may comprise an integrated battery. The resonant receiver may be configured to automatically charge said battery upon receiving power.

According to a fourth aspect, there is described a non-combustible aerosol generating device comprising a resonant receiver as set out above with reference to the first aspect. The aerosol generating device may be configured to receive a removable article comprising an aerosol generating material. The aerosol generating material may comprise an aerosol generating substrate and an aerosol forming material. The non-combustible aerosol generating device may comprise a tobacco heating system.

According to a fifth aspect, there is describes a non-combustible aerosol generating device comprising a resonant receiving component (such as the resonant receiver as set out above with reference to the first aspect).

### BRIEF DESCRIPTION OF THE DRAWINGS

Example embodiments will now be described by way of non-limiting example, with reference to the accompanying drawings, in which:

FIG. 1 is a block diagram of a rechargeable non-combustible aerosol generating device, in accordance with an example embodiment;

FIG. 2 is a block diagram of a system or kit of parts, in accordance with an example embodiment;

FIG. 3 shows a system or a kit of parts, in accordance with an example embodiment;

FIG. 4 shows a transmit coil, in accordance with an example embodiment;

FIGS. 5 to 8 show wireless chargers, in accordance with example embodiments;

FIG. 9 shows a resonant receiver, in accordance with an example embodiment;

FIG. 10 shows a resonant receiver, in accordance with an example embodiment;

FIGS. 11 to 15 show systems (or a kit of parts), in accordance with example embodiments;

FIG. 16 shows a wireless charger in exploded view, in accordance with an example embodiment;

FIG. 17 is a flow diagram, according to one or more example embodiments; and

FIG. 18 is a flow diagram, according to one or more example embodiments.

### DETAILED DESCRIPTION

As used herein, the term “delivery system” is intended to encompass systems that deliver at least one substance to a user, and includes non-combustible aerosol provision systems that release compounds from an aerosol-generating material without combusting the aerosol-generating material, such as electronic cigarettes, tobacco heating products, and hybrid systems to generate aerosol using a combination of aerosol-generating materials.

According to the present disclosure, a “combustible” aerosol provision system is one where a constituent aerosol-generating material of the aerosol provision system (or component thereof) is combusted or burned during use in order to facilitate delivery of at least one substance to a user. According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system. In some embodiments, the non-combustible aerosol provision system is an electronic cigarette, also known as a vaping device or electronic nicotine delivery system (END), although it is noted that the presence of nicotine in the aerosol generating material is not a requirement. In some embodiments, the non-combustible aerosol provision system is an aerosol-generating material heating system, also known as a heat-not-burn system. An example of such a system is a tobacco heating system. In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device. In some embodiments, the disclosure relates to consumables comprising aerosol generating material and configured to be used with non-combustible aerosol provision devices. These consumables are sometimes referred to as articles throughout the disclosure. In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energised so as to distribute power in the form of heat to an aerosol-generating material or to a heat transfer material in proximity to the exothermic power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

In some embodiments, the substance to be delivered may be an aerosol-generating material or a material that is not intended to be aerosolised. As appropriate, either material may comprise one or more active constituents, one or more flavours, one or more aerosol-former materials, and/or one or more other functional materials.

In some embodiments, the substance to be delivered comprises an active substance. The active substance as used herein may be a physiologically active material, which is a material intended to achieve or enhance a physiological response.

Aerosol-generating material is a material that is capable of generating aerosol, for example when heated, irradiated or energized in any other way. Aerosol generating material may, for example, be in the form of a solid, liquid or gel which may or may not contain an active substance and/or flavourants.

The aerosol-generating material may comprise one or more active substances and/or flavours, one or more aerosol-former materials, and optionally one or more other functional material.

The material may be present on or in a support, to form a substrate. The support may, for example, be or comprise paper, card, paperboard, cardboard, reconstituted material, a plastics material, a ceramic material, a composite material, glass, a metal, or a metal alloy. In some embodiments, the support comprises a susceptor. In some embodiments, the susceptor is embedded within the material. In some alternative embodiments, the susceptor is on one or either side of the material.

A consumable is an article comprising or consisting of aerosol-generating material, part or all of which is intended to be consumed during use by a user. A consumable may comprise one or more other components, such as an aerosol-generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor.

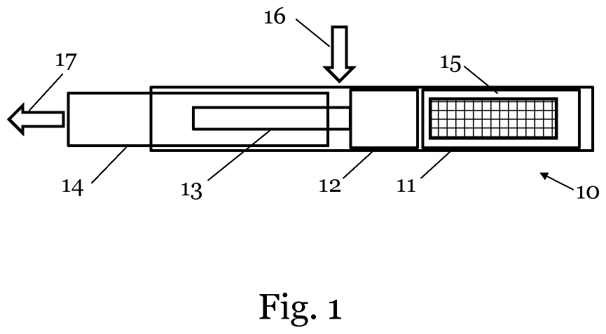

FIG. 1 is a block diagram of a rechargeable non-combustible aerosol generating device, indicated generally by the reference numeral 10, in accordance with an example embodiment. The aerosol provision device 10 comprises a battery 11, a control circuit 12, a heater 13 and a consumable 14 (e.g. a tobacco consumable, for example in the form of a tobacco stick). The device also includes a resonant receiver 15, for example in the form of an antenna. As discussed in detail below, the antenna of the resonant receiver 15 may be used to receive magnetic field energy for use in charging the battery 11 (e.g. under the control of the control circuit 12). The example resonant receiver 15 is shown provided near the battery 11; however, this is one of many example locations.

In the use of the device 10, the heater 13 is inserted into the consumable 14, such that the consumable may be heated to generate an aerosol (and tobacco flavour, in the case of a tobacco consumable) for the user. When a user inhales at the end of the consumable, as indicated by arrow 17, the air is drawn into the device 10, through an air inlet as indicated by arrow 16, then passes through the consumable, delivering the aerosol (and tobacco flavour, in the case of a tobacco consumable) to the user.

The aerosol provision device 10 is described by way of example only. Many alternative aerosol provision devices may be used in example implementations of the principles described herein. For example, the device 10 may be replaced within a vaping device in which an aerosol generating material (e.g. a liquid) is heated to generate the aerosol. The principles of the present disclosure are not limited to a particular type of aerosol provision device 10 (that is to say, the aerosol provision device 10 may be arranged to aerosolise a solid, liquid or other aerosol-generating material via any suitable electrically powered or controller aerosol generator, such as a heater, a vibrating mesh, a source of irradiation, an electrically controller pressurised cannister which may include an electrically operated release valve, etc.).

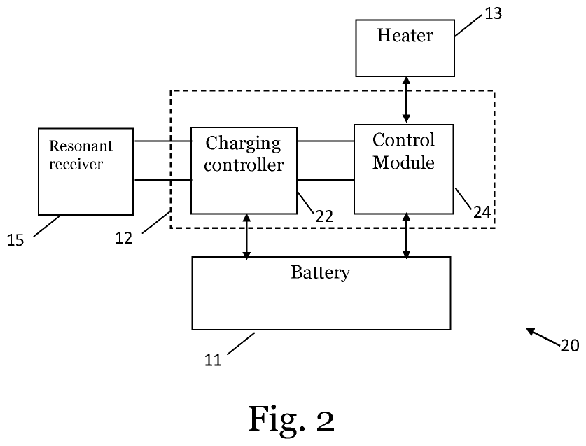

FIG. 2 is a block diagram of a system or kit of parts, indicated generally by the reference numeral 20, in accordance with an example embodiment. The system 20 comprises the battery 11, the control circuit 12, the heater 13 (or more generally, the aerosol generator) and the resonant receiver 15 of the aerosol provision device 10 described above. The control circuit 12 of the system 20 comprises a charging controller 22 and a control module 24.

The resonant receiver 15 may be used to receive a magnetic field for use in charging the battery 11 (e.g. under the control of the control circuit 12). Furthermore, the charging controller 22 may be configured to charge the battery 11 (e.g. under the control of the control module 24) with power extracted from the magnetic field.

It should be noted that, in some example embodiments, the functionality of the control module 24 is implemented by the charging controller 22. Indeed, the control module 24 may be omitted from some example embodiments.

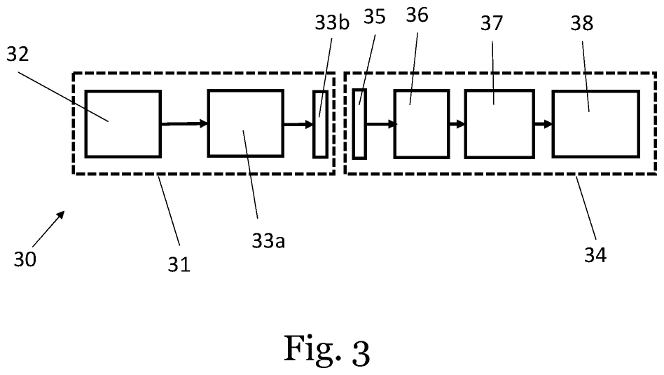

FIG. 3 shows a system or a kit of parts, indicated generally by reference numeral 30, in accordance with an example embodiment.

The system or kit of parts 30 comprises a wireless charger 31 according to some example embodiments; and one or more chargeable aerosol generating devices 34 (one is shown in FIG. 3) according to some embodiments. The wireless charger 31 may comprise a transformer 32 (which may be connectable to mains power or a battery).

The charger 31 may further comprise a high frequency inverter 33a configured to convert electrical energy into a magnetic field. The charger 31 may further comprise a transmit coil (Tx coil) 33b arranged to radiate the magnetic field from the charger 31 within a charging zone.

The aerosol generating device 34 may comprise a receive coil (Rx coil) 35. When the Rx coil 35 is placed within the charging zone of the Tx coil 33b, the coils are electrically coupled. When electrically coupled to the Tx coil 33b, the Rx coil 35 converts the magnetic field energy into electrical energy. The aerosol generating device 34 may further comprise a rectifier 36 configured to convert the received electrical energy from an Alternating Current (AC) to a Direct Current (DC). The aerosol generating device 34 may further comprise an integrated battery 37; the battery 37 may be battery 11 above. The electrical energy may then be used to charge the battery 37. The aerosol generating device 34 may further comprise a heater 38 for heating consumables to generate an aerosol; as discussed above.

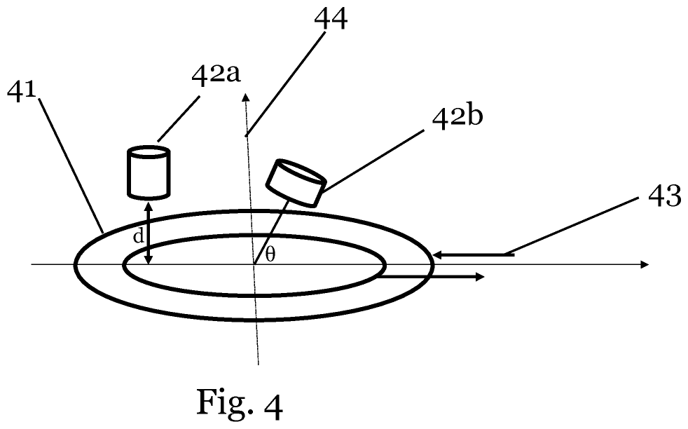

FIG. 4 shows a transmit coil (Tx coil) 41 in accordance with an example embodiment. The Tx coil 41 may be the Tx coil 33b of the system 30 described above. The Rx coils 42a, 42b shown in FIG. 4 may be the Rx coil 35 of the system 30 described above.

The Tx coil 41 may comprise one or more rings arranged coaxially. The rings may be arranged in the same plane or separated into two or more substantially parallel planes. The rings may be circular, square or rectangular but are not limited to these shapes. The rings may have the same diameter or different diameters. The Tx coil 41 may be connected to a power supply 43; for example an AC or DC power supply. The Tx coil 41 is configured for radiating electrical power into the charging zone by magnetic resonance. The Tx coil 41 therefore radiates a magnetic field in a y-direction 44. The y-direction 44 is a substantially orthogonal direction to the plane of the rings of the Tx

### Coil 41.

The Tx coil 41 may interact with one or more receive (Rx) coil. Two example Rx coils 42a, 42b are shown in FIG. 4. Each Rx coil 42a, 42b may comprise one or more rings arranged coaxially. The rings may be arranged in the same plane or separated into two or more substantially parallel planes. The rings may be circular, square or rectangular but are not limited to these shapes. The rings may comprise the same diameter or different diameters. The Rx coils 42a, 42b are configured to receive a magnetic field from a Tx coil 41 to transfer the electrical power by magnetic resonance induction. The Rx coils 42a, 42b therefore absorb a magnetic field in from the Tx coil 41 when their planes are parallel or at a range of angles to one another. The Rx coil 42a is shown as arranged a distance d from the Tx coil 41 and substantially parallel to the Tx coil 41. The Rx coil 42 b is shown as arranged at an angle 0 to the Tx coil 41. Angle 0 may be any obtuse angle.

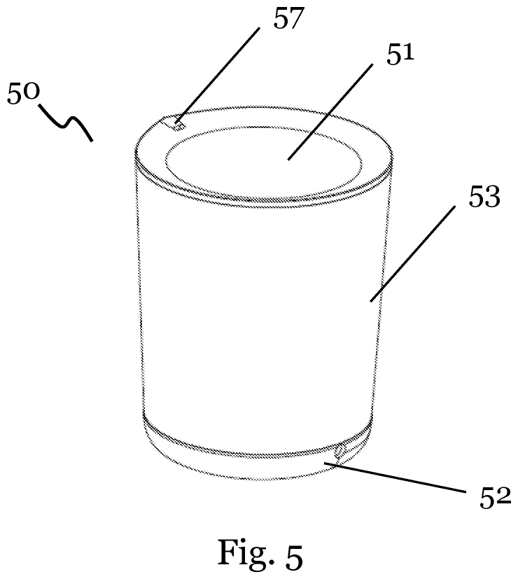

FIG. 5 shows a wireless charger, indicated generally by the reference numeral 50, in accordance with an example embodiment.

The wireless charger 50 is a generally cup-shaped charger comprises a charging zone 51 for receiving one or more chargeable aerosol generating devices (not shown). The or each chargeable aerosol generating device may comprise a resonant receiver. The charging zone 51 may comprise a base 52. The base 52 may comprise a resonant transmitter (not shown) configured to transmit electrical power to the one or more resonant receivers (when located within the charging zone 51) through magnetic resonance induction.

In some example embodiments, the wireless charger 50 comprises walls 53 extending transversely from said base 52. The walls 53 are suitable for supporting said chargeable aerosol generating device(s) (not shown) in a substantially upright position relative to said base 52. In some example embodiments, the walls 53 are substantially orthogonal to the base 52; however, alternatives angles are possible. For example, some embodiments comprise walls 53 that are at a substantially obtuse angle to said base 52.

The walls 53 of the wireless charger 50 may extend the full perimeter of the base 52, thus forming an enclosure around the charging zone 51. In some embodiments, the walls 53 for a cup-shaped enclosure around the charging zone 51. The cup-shaped charging zone may have a substantially circular cross section however embodiments are not limited to this shape and may include (but not limited to) substantially square or rectangular cross sections.

In some embodiments the base 52 further comprises a socket (not shown) for connecting a power cable to the resonant transmitter. For example, the socket may be for a barrel type DC connector.

In some embodiments, the charger 50 comprises a charging indicator light 57. The light 57 may be configured to illuminate when a resonant receiver is placed in the charging zone 51 and has successfully coupled to the resonant transmitter.

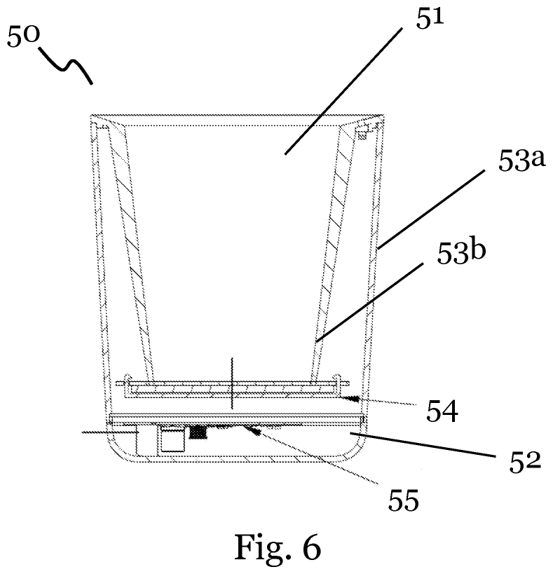

FIG. 6 shows is a cross sectional view of wireless charger 50.

The walls 53 may comprise an outer shell 53a angled substantially orthogonally to the base 52 and an internal shell 53b which tapers outwardly from the base 52. The base 52 may comprise a resonant transmitter comprising a transmit coil (Tx coil) 54 and a transmitter circuit 55. The Tx coil 54 is arranged towards the base of the charging zone 51 such that the plane of the Tx coil 54 is substantially orthogonal to the outer shell 53a. The Tx coil 54 may comprise one or more circular coils (not shown). The Tx coil 54 may be configured to radiate a magnetic field into the charging zone 51. The transmitter circuit 55 may be enclosed inside the base 52. The transmitter circuit 55 may comprise a Printed Circuit Board Assembly (PCBA). The transmitter circuit 55 may comprise a DC-AC converter (not shown) and a control circuit (not shown). The Tx coil 54 and transmitter circuit 55 may be separated by a ferromagnetic material.

In some example embodiments, the resonant transmitter is further configured to transmit power automatically when resonantly coupled with a resonant receiver.

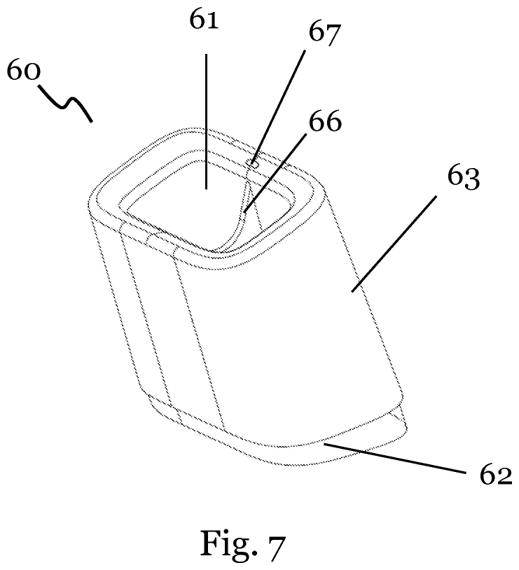

FIG. 7 shows a wireless charger, indicated generally by the reference numeral 60, in accordance with an example embodiment.

The wireless charger 60 comprises a charging zone 61 for receiving one or more chargeable aerosol generating devices (not shown). The or each chargeable aerosol generating device may comprise a resonant receiver. The charging zone 61 may comprise a base 62. The base 62 may comprise a resonant transmitter (not shown) configured to transmit electrical power to the one or more resonant receivers through magnetic resonance induction.

In some embodiments, the wireless charger 60 comprises walls 63 extending transversely from said base 62. The walls 63 are suitable for supporting said chargeable aerosol generating device(s) (not shown) in a substantially upright position relative to said base 62. In some embodiments, the walls 63 are at a substantially obtuse angle to the base 62 such that the charging zone 61 is tilted with respect to the base 62. For example, the walls 63 may be angled between 105 to 120 degrees to said base 62; however, embodiments are not limited to these angles.

The walls 63 of the wireless charger 60 may extend the full perimeter of the base 62 thus forming an enclosure around the charging zone 61. In some embodiments, the walls 63 for a cup-shaped enclosure around the charging zone 61. The cup-shaped charging zone 61 may have a substantially square cross section but is not limited to this shape. For example, the charging zone 61 may have a circular or rectangular cross section.

The charging zone 61 may comprise a partition 66 through the centre thereby providing two separate enclosures within the charging zone 61.

In some embodiments the base 62 further comprises a socket (not shown) for connecting a power cable to the resonant transmitter. For example, the socket may be for a barrel type DC connector.

In some embodiments, the charger 60 comprises a charging indicator light 67. The light 67 may be configured to illuminate when a resonant receiver is placed in the charging zone 61 and has successfully coupled to the resonant transmitter.

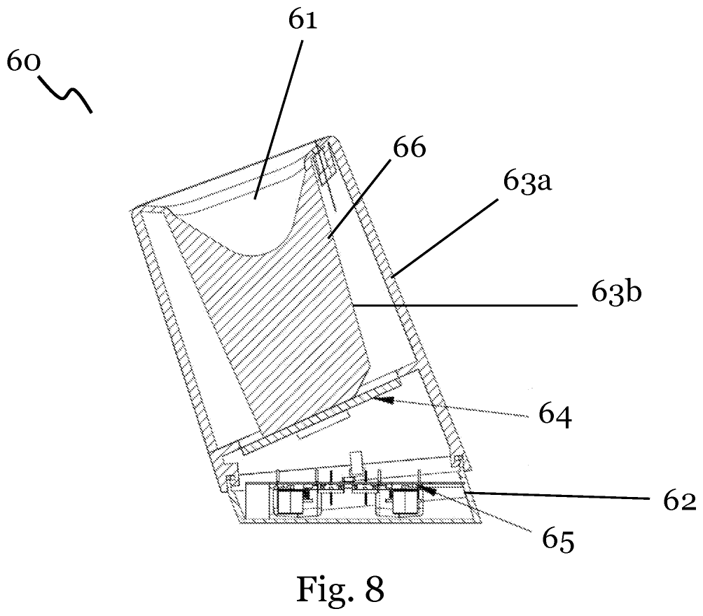

FIG. 8 is a cross sectional view of wireless charger 60.

The walls 63 may comprise an outer shell 63a angled at an obtuse angle to the base 62 and an inner shell 63b that tapers outwardly from the base 62. The base 62 may comprise a resonant transmitter comprising a transmit coil (Tx coil) 64 and a transmitter circuit 65. The Tx coil 64 is arranged towards the base of the charging zone 61 such that the plane of the Tx coil 64 is substantially orthogonal to the outer shell 63a. The Tx coil 64 may comprise one or more square coils (not shown). The Tx coil 64 may be configured to radiate a magnetic field into the charging zone 61. The transmitter circuit 65 may be enclosed inside the base 62. The transmitter circuit 65 may comprise a PCBA. The transmitter circuit 65 may comprise a DC-AC converter (not shown) and a control circuit (not shown). The Tx coil 64 and transmitter circuit 65 may be separated by a ferromagnetic material.

In some embodiments, the resonant transmitter is further configured to transmit power automatically when resonantly coupled with a resonant receiver.

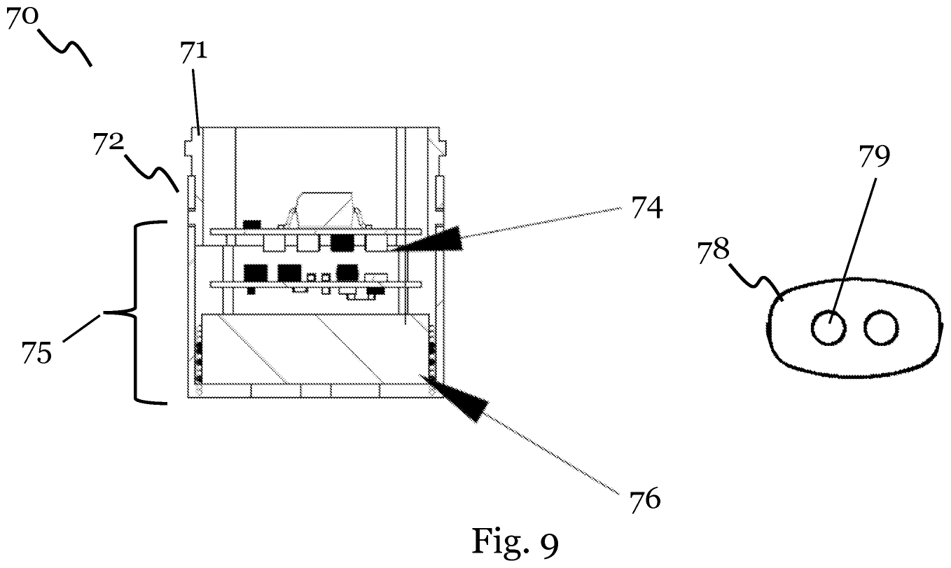

FIG. 9 shows a resonant receiver, indicated generally by reference numeral 70, in accordance with an example embodiment. The figure shows a cutaway side view 72 of the resonant receiver 70 and a plan view 78.

The resonant receiver 70 comprises a first circuit 75. The first circuit 75 comprises a receiver circuit 74 and Rx coil 76. The first circuit 75 is housed in a non-metallic shell 71. The Rx coil 76 is arranged at one end of the shell 71 to align with a Tx coil when placed in a wireless charger (as described above). A connector 79 is arranged at the opposite end of the shell 71 to enable the resonant receiver 70 to be removably connected to a charging port of an electrically chargeable aerosol generating device (as described above). The first circuit 75 is configured to receive electrical power (from a resonant transmitter) by magnetic resonance induction. The connector 79 transfers at least some of said received electrical power to said electrically chargeable aerosol generating device when connected to the charging port of the device. The connector 79 is detachable from the charging port; for example the connector 79 is a 2 pin connector.

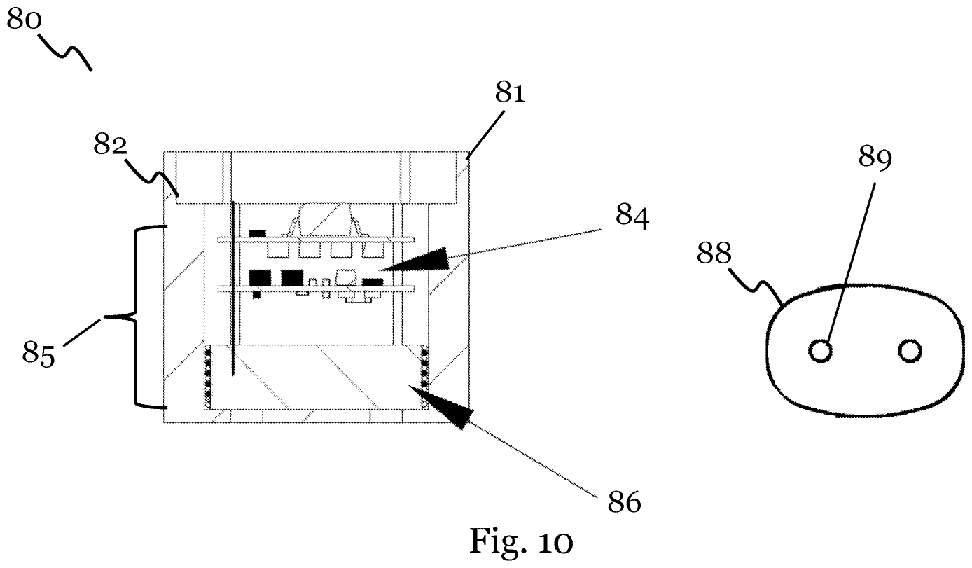

FIG. 10 shows a resonant receiver, indicated generally by reference numeral 80, in accordance with an example embodiment. The figure shows a cutaway side view 82 of the resonant receiver 80 and a plan view 88.

The resonant receiver 80 comprises a first circuit 85. The first circuit 85 comprises a receiver circuit 84 and Rx coil 86. The first circuit 85 is housed in a non-metallic shell 81. The Rx coil 86 is arranged at one end of the shell 81 to align with a Tx coil when placed in a wireless charger (as described above). A connector 89 is arranged at the opposite end of the shell 81 to enable the resonant receiver 80 to be removably connected to a charging port of an electrically chargeable aerosol generating device (as described above). The first circuit 85 is configured to receive electrical power (from a resonant transmitter) by magnetic resonance induction. The connector 89 transfers at least some of said received electrical power to said electrically chargeable aerosol generating device when connected to the charging port of the device. The connector 89 is detachable from the charging port; for example the connector 79 is a 2 pin connector.

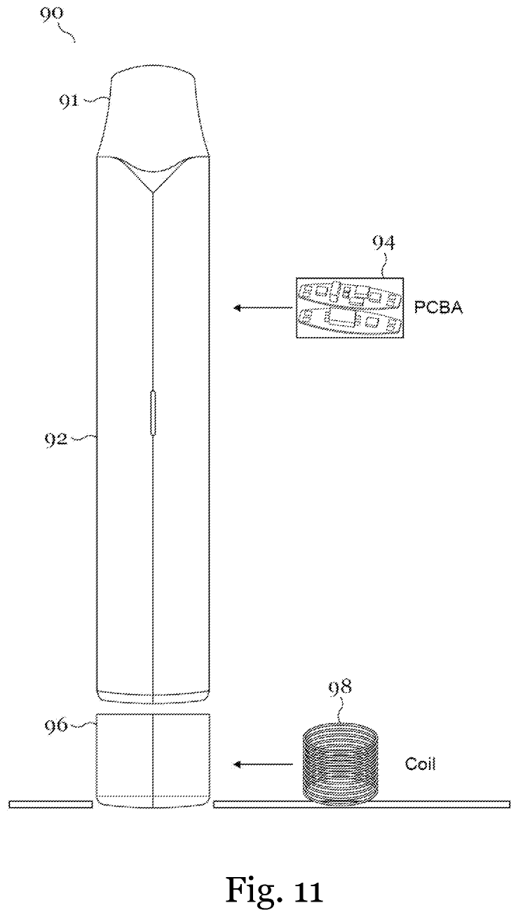

FIG. 11 shows a system or a kit of parts, indicated generally by reference numeral 90, in accordance with an example embodiment. The system 90 comprises an electrically rechargeable (non-combustible) aerosol generating device 92 and a resonant receiver 96. The system 90 may be the same or similar to the system 20 described above in relation to FIG. 2.

The device 92 is configured to receive a removable article comprising an aerosol generating material (not shown). For example, the aerosol generating material may comprise an aerosol generating substrate and an aerosol forming material. The removable article may comprise a susceptor arrangement or some other heating system (e.g. a tobacco heating system).

In some embodiments, the resonant receiver 96 is configured to automatically charge said battery upon receiving power.

The resonant receiver 96 may comprise a first circuit configured to receive electrical power (from a resonant transmitter) by magnetic resonance induction. The first circuit may be implemented on a PCBA.

The resonant receiver 96 may further comprise a connector (not shown) for connecting to a charging port of the device 92 and transferring received electrical power to the device 92. In some example embodiments, the connector is detachable from the charging port. In other embodiments, the connector is non-detachable from the charging port.

The first circuit may comprise a receive coil (Rx coil) 98 which may be the same or similar to Rx coil 42a, 42b described above in relation to FIG. 4.

The first circuit may comprise a rectifier; which may be the same or similar to rectifier 36 described above in relation to FIG. 3.

The device 92 may comprise a charging port (not shown) at one end of the device 92. The charging port may be suitable for connecting to a connector of a resonant receiver 96; as discussed above. In some embodiments, the charging port may also be suitable for connecting to a charging cable; for charging the device 92 directly from mains power or a battery. The device 92 may comprise a second circuit 94. The second circuit 94 may comprise a charging controller and/or a control module; which may be the same or similar to charging controller 22 and control module 24 described above in relation to FIG. 2. The second circuit 94 may be implemented on a PCBA.

The device 92 may further comprise a heater (not shown) arranged to use the received electrical power to heat aerosol generating materials.

The device 92 may further comprise an integrated battery (not shown). The integrated battery may be connected to said second circuit 94 such that electrical power transferred from the resonant receiver 96 charges the battery.

The device 92 further comprises a mouthpiece 91, arranged at an opposite end of the device 92, to enable a user to inhale generated aerosols.

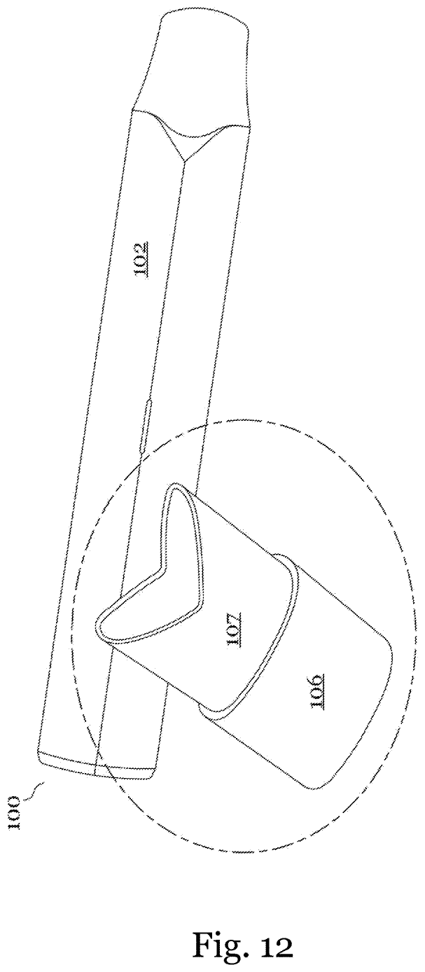

FIG. 12 shows a system or a kit of parts, indicated generally by reference numeral 100, in accordance with an example embodiment. The kit of parts 100 may comprise one or more electrically rechargeable (non-combustible) aerosol generating device(s) 102 and one or more resonant receivers 106.

The device 102 comprises a charging port at one end which is connectable to a connector on a resonant receiver 106.

The resonant receiver 106 comprises a first circuit configured to receive electrical power by magnetic resonance induction. The first circuit may be housed in a non-metallic shell; for example rubber or plastic. The resonant receiver 106 further comprises a connector (not shown) for connecting to a charging port (not shown) of an electrically chargeable aerosol generating device 102. For example, the connector may be a 2-pin connector.

The connector transfers at least some of the received electrical power to a battery in the electrically chargeable aerosol generating device 102. The connector may be detachable from the charging port and thus detachable from the device 102.

The resonant receiver 106 further comprises a securing arrangement 107 for securing the connector to said charging port; thus securing the resonant receiver 106 to the device 102. For example, the securing arrangement 107 may comprise a collar which can be inserted into the charging port and provide an interference fit. In some embodiments, the securing arrangement 107 comprises a magnet.

In some embodiments, the device 92 or 102 may comprise a resonant receiving component. The resonant receiving component may be integrated in the device and thus is non-detachable.

In use, a resonant receiver 96, 106 is connected to a charging port of an electrically chargeable aerosol generating device 92, 102. The device 92, 102 is configured to receive electrical power, at a first circuit of said resonant receiver, by magnetic resonance induction; for example from a resonant transmitter described above. The device 92, 102 is further configured to transfer at least some of said received electrical power to said device 92, 102; for example to an integrated battery in the device 92, 102. The connector may be secured to said charging port. The resonant receiver 96, 106 may be detached from the charging port of said electrically chargeable aerosol generating device 92, 102.

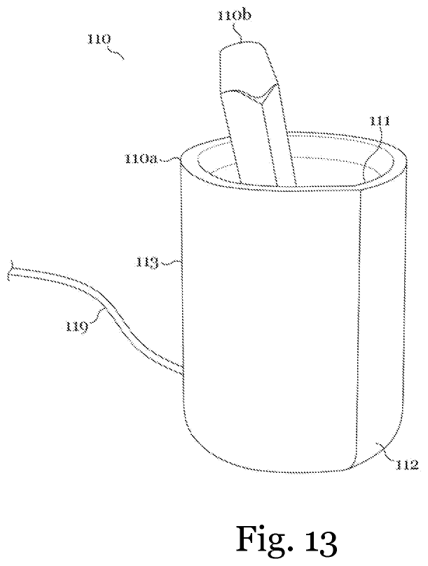

FIG. 13 shows a system or a kit of parts, indicated generally by the reference numeral 110, in accordance with an example embodiment. The system 110 comprises a wireless charger 110a and an electrically rechargeable aerosol generating device 110b.

The wireless charger 110a comprises a charging zone 111 for receiving one or more chargeable aerosol generating devices 110b. The charging zone 111 is cup-shaped, having a circular cross section. The walls 113 defining the charging zone 111 are substantially vertical with respect to a base 112 of the charging zone 111. The wireless charger 110a is connected to mains power by a power cable 119 which supplies DC electrical power to a resonant transmitter (not shown) in the wireless charger 110a. The power cable 119 may be detachable from a socket in the wireless charger 110a; for example using a DC barrel connector.

In FIG. 13, one device 110b is received in the charging zone 111 and is held largely upright by the walls 113 of the charging zone 111. Two or more devices 110b may be received in the charging zone 111. One end of the device 110b comprises a mouthpiece (for inhaling generated aerosols). A resonant receiver is arranged at the opposite end (not shown). The chargeable aerosol generating device 110b comprises a resonant receiver. The charging zone 111 comprises a base 112 and a resonant transmitter (not shown) is arranged in or near to the base 112. The resonant transmitter may be at least partially enclosed within said charging zone 111. The resonant transmitter may be configured to generate a magnetic field in a direction that is substantially orthogonal to said base. The resonant transmitter is configured to transmit electrical power to said one or more resonant receivers (when received by the charging zone 111) through magnetic resonance induction. The charging zone 111 may be wide enough to receive a plurality of (i.e. one or more additional devices 110b) and thus may charge them all simultaneously.

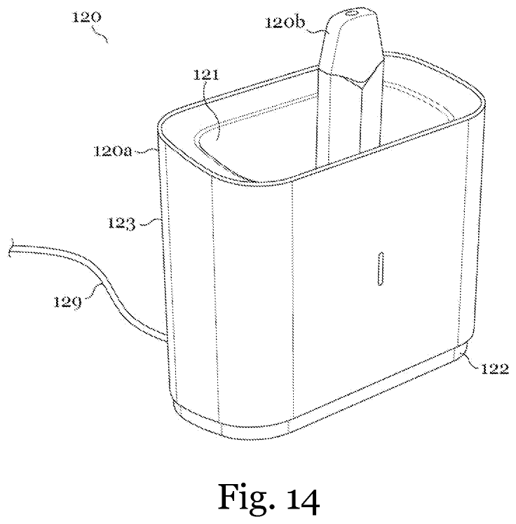

FIG. 14 shows a system or a kit of parts, indicated generally by the reference numeral 120, in accordance with an example embodiment. The system 120 comprises a wireless charger 120a and an electrically rechargeable aerosol generating device 120b.

The wireless charger 120a comprises a charging zone 121 for receiving one or more chargeable aerosol generating devices 120b. The charging zone 121 is cup-shaped, having a rectangular cross section. The walls 123 defining the charging zone 111 are tilted with respect to a base 122 of the charging zone 121. The tilt is an obtuse angle relative to the base 122; for example between 100-120 degrees. The wireless charger 120a is connected to mains power by a power cable 129 which supplies DC electrical power to a resonant transmitter (not shown) in the wireless charger 120a. The power cable 129 may be detachable from a socket in the wireless charger 120a; for example using a DC barrel connector.

In FIG. 14, one device 120b is received in the charging zone 121 and is held substantially upright by the walls 123 of the charging zone 121. Two or more devices 120b may be received in the charging zone 121. One end of the device 120b comprises a mouthpiece (for inhaling generated aerosols). A resonant receiver is arranged at the opposite end (not shown). The chargeable aerosol generating device 120b comprises a resonant receiver. The charging zone 121 comprises a base 122 and a resonant transmitter (not shown) is arranged in or near to the base 122. The resonant transmitter may be at least partially enclosed within said charging zone 121. The resonant transmitter may be configured to generate a magnetic field in a direction that is substantially orthogonal to said base 122. In other embodiments, the resonant transmitter may be configured to generate a magnetic field in a direction that is substantially parallel to the walls 123.

The resonant transmitter is configured to transmit electrical power to said one or more resonant receivers (when received by the charging zone 121) through magnetic resonance induction. The charging zone 121 may be wide enough to receive a plurality of (i.e. one or more additional devices 120b) and thus may charge them all simultaneously.

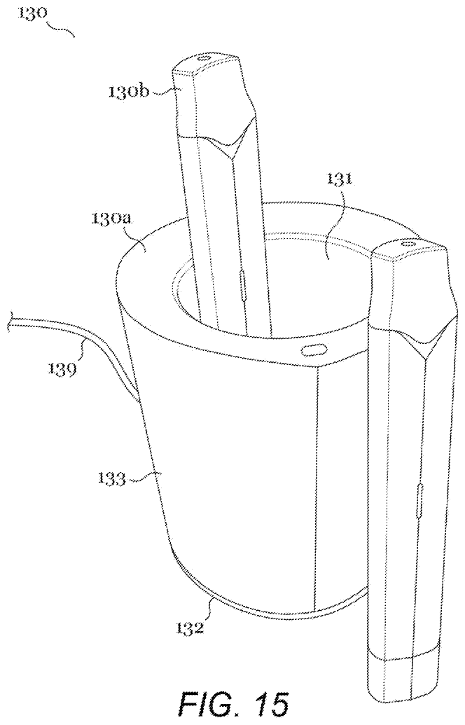

FIG. 15 shows a system or a kit of parts, indicated generally by the reference numeral 130, in accordance with an example embodiment. The system 130 comprises a wireless charger 130a and an electrically rechargeable aerosol generating device 130b.

The wireless charger 130a comprises a charging zone 131 for receiving one or more chargeable aerosol generating devices 130b. The charging zone 131 is cup-shaped, having a circular cross section. The walls 133 defining the charging zone 131 are tapered outwardly from the base 132 of the charging zone 131. The taper is an obtuse angle relative to the base 132; for example between 100-120 degrees. The wireless charger 130a is connected to mains power by a power cable 139 which supplies DC electrical power to a resonant transmitter (not shown) in the wireless charger 130a. The power cable 139 may be detachable from a socket in the wireless charger 130a; for example using a DC barrel connector.

In FIG. 15, one device 130b is received in the charging zone 131 and is held substantially upright by the walls 133 of the charging zone 131. One end of the device 130b comprises a mouthpiece (for inhaling generated aerosols). A resonant receiver is arranged at the opposite end (not shown). The chargeable aerosol generating device 130b comprises a resonant receiver. The charging zone 131 comprises a base 132 and a resonant transmitter (not shown) is arranged in or near to the base 132. The resonant transmitter may be at least partially enclosed within said charging zone 131. The resonant transmitter may be configured to generate a magnetic field in a direction that is substantially orthogonal to said base 132. The resonant transmitter is configured to transmit electrical power to said one or more resonant receivers (when received by the charging zone 131) through magnetic resonance induction. The charging zone 131 may be designed such that a device 130b may be placed at any angle or position in the charging zone 131 for charging; due to the use of magnetic resonance induction. The charging zone 131 may be wide enough to receive a plurality of (i.e. one or more additional devices 130b) and thus may charge them all simultaneously.

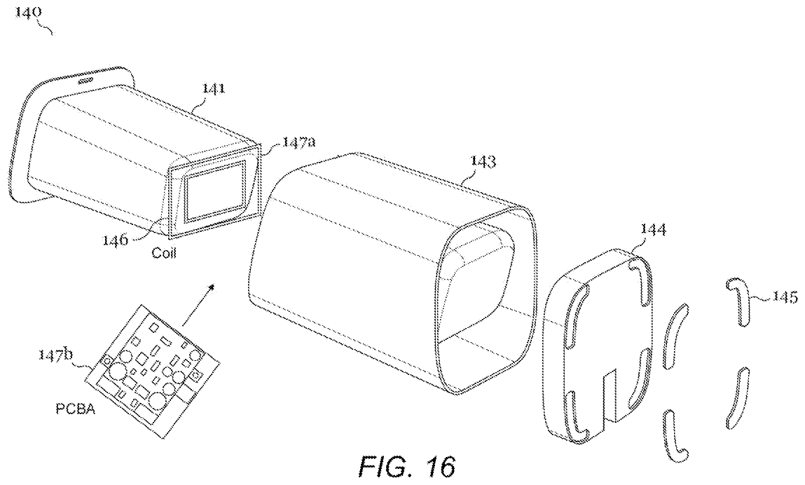

FIG. 16 shows a wireless charger in exploded view, indicated generally by reference numeral 140, in accordance with an example embodiment.

The wireless charger 140 comprises a cup-shaped charging zone 141 for receiving one or more chargeable aerosol generating devices (not shown). The cup-shaped charging zone 141 has a rectangular cross section. The or each chargeable aerosol generating device each comprise a resonant receiver; which may be detachable. The charging zone comprises a base 146 and a resonant transmitter (comprising a coil 147a and transmitter circuit 147b). The transmitter circuit 147b may be implemented on a PCBA. The resonant transmitter is configured to transmit electrical power to said one or more resonant receivers through magnetic resonance induction.

The wireless charger 140 further comprises an outer shell 143 shaped to receive the cup-shaped charging zone 141; the charging zone 141 may be removable from the outer shell 143. The outer shell 143 may comprise a charging indicator light such as a Light Emitting Diode (LED); as described above. The wireless charger 140 further comprises an outer base 144 which removably attaches to the base of the outer shell 143. Silicone feet 145 may be attached to the base of the outer base 144 for gripping a surface. The cup-shaped charging zone 141 may comprise silicone; which may be molded. The outer shell 143 and out base 144 may be at least partially formed from a plastic material. The charging zone 141, outer shell 143, outer base 144 may be formed to be dustproof and/or waterproof.

In use, the charging zone 141 receive one or more chargeable aerosol generating devices, wherein the or each chargeable aerosol generating device comprise a resonant receiver. The wireless charger 140 transmits electrical power from a resonant transmitter 147a, 147b to said one or more resonant receivers through magnetic resonance induction. Transmitting electrical power comprises generating a magnetic field in a direction that is substantially orthogonal to a base 146, 144 of said wireless charger 140. In some embodiments, said power is transmitted automatically when the wireless charger 140 is coupled with a resonant receiver.

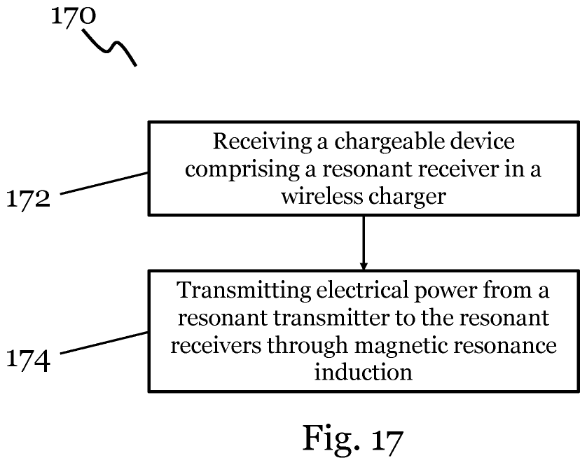

FIG. 17 is a flow diagram, indicated generally by reference numeral 170, according to one or more example embodiments. The flow diagram 170 may correspond to a method for charging a chargeable aerosol generating device in a wireless charger.

A first step 172 comprises receiving one or more chargeable aerosol generating devices in a charging zone of a wireless charger, wherein the or each chargeable aerosol generating device comprising a resonant receiver.

A second step 174 comprises transmitting electrical power from a resonant transmitter to said one or more resonant receivers through magnetic resonance induction.

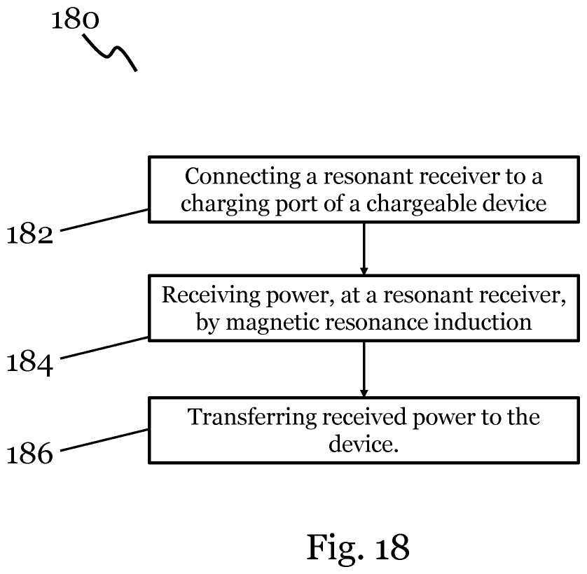

FIG. 18 is a flow diagram, indicated generally by reference numeral 180, according to one or more example embodiments. The flow diagram 180 may correspond to a method for connecting a resonant receiver to a charging port of an electrically chargeable aerosol generating device.

A first step 182 comprises connecting a resonant receiver to a charging port of an electrically chargeable aerosol generating device.

A second step 184 comprises receiving electrical power, at a first circuit of said resonant receiver, by magnetic resonance induction.

A third step 186 comprises transferring at least some of said received electrical power to said electrically chargeable aerosol generating device.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures and/or other aspects described herein are not to be considered limitations of the scope of the invention as defined by the claims or limitations on equivalents to the claims, and that other embodiments may be utilised and modifications may be made without departing from the scope of the claimed invention. Various embodiments of the invention may suitable comprise, consists of, or consist essentially of appropriate combinations of the disclosed elements, components, features, parts, steps, means, etc., other than those specifically described herein. In addition, this disclosure may include other inventions not presently claimed, which may be claimed in future.

1. A resonant receiver comprising:
a first circuit configured to receive electrical power by magnetic resonance induction; and
a connector for connecting to a charging port of an electrically chargeable aerosol generating device and transferring at least some of said received electrical power to said electrically chargeable aerosol generating device, wherein said connector is detachable from said charging port.

2. A resonant receiver according to claim 1, further comprising a securing arrangement for securing the connector to said charging port.

3. A resonant receiver according to claim 2, wherein securing arrangement comprises a magnet.

4. A resonant receiver according to claim 1, wherein said connector is a 2-pin connector.

5. A resonant receiver according to claim 1, wherein the first circuit comprises a receive coil.

6. A resonant receiver according to claim 1, wherein the first circuit comprises a rectifier.

7. A resonant receiver according to claim 1, wherein the first circuit is housed in a non-metallic shell.

8. A kit of parts comprising:
an electrically chargeable aerosol generating device; and
the resonant receiver according to claim 1, wherein said resonant receiver is detachable from said electrically chargeable aerosol generating device.

9. A kit of parts according to claim 8, wherein said electrically chargeable aerosol generating device comprises an integrated battery.

10. A kit of parts according to claim 9, wherein said resonant receiver is configured to automatically charge said battery upon receiving power.

11. A non-combustible aerosol generating device comprising a resonant receiver according to claim 1.

12. A non-combustible aerosol generating device according to claim 11, wherein the aerosol generating device is configured to receive a removable article comprising an aerosol generating material.

13. A non-combustible aerosol generating device according to claim 12, wherein said aerosol generating material comprises an aerosol generating substrate and an aerosol forming material.

14. A non-combustible aerosol generating device according to claim 11, wherein the non-combustible aerosol generating device comprises a tobacco heating system.

15. A non-combustible aerosol generating device comprising a resonant receiving component.

16. A method comprising:
connecting a resonant receiver to a charging port of an electrically chargeable aerosol generating device;
receiving electrical power, at a first circuit of said resonant receiver, by magnetic resonance induction; and
transferring at least some of said received electrical power to said electrically chargeable aerosol generating device.

17. A method according to claim 16, further comprising securing the connector to said charging port.

18. A method according to claim 16, further comprising detaching said resonant receiver from the charging port of said electrically chargeable aerosol generating device.
